(19) United States
(12) Patent Application Publication
(10) Pub. No.: US 2011/0272052 A1
(43) Pub. Date: Nov. 10, 2011

(54) Rodent Guard

(76) Inventor: Niels Arne Lauridsen, Varde (DK)

(21) Appl. No.: 13/101,466

(22) Filed: May 5, 2011

(30) Foreign Application Priority Data
May 5, 2010 (DK) PA 2010 70188

(51) Int. Cl. F16L 55/00; B23P 19/00

(52) U.S. Cl. 138/103; 29/428

(57) ABSTRACT

Rodent guard for installation in a substantially circular pipe opening, where said guard comprises a flexible shield and two barriers pivotably suspended from said shield, where said barriers are arranged in close proximity of each other, and where each barrier has a blade and a mounting member projecting from said blade, where the mounting member comprises means for pivotably mounting the barrier in the shield, and that in a distal portion of the mounting member means are provided for engaging the other barrier and/or the other barrier's mounting member in a certain relative position of the two barriers.

### FIELD OF THE INVENTION

The present invention relates to a rodent guard for installation, in a substantially circular pipe opening such as for example a sewer as well as a method for installing a rodent guard according to the present invention in a sewer.

### BACKGROUND OF THE INVENTION

Rodents such as particularly rats are becoming an increasing problem in built-up areas and more and more devices as well as new poisons are being developed in order to catch, exterminate and deter rats from entering houses, warehouses, factories and other facilities where it is highly undesirable that these rodents enter.

One method of avoiding rats entering such facilities is to install implements in the sewer system which implements the rats are not able to pass, but which let the sewer flow pass unhindered.

One such example is known from EP 1828498 which discloses a rat barrier comprising a shield inside which pivotable barriers are arranged. The barriers are arranged for pivotal movement about axles arranged inside the shield. The shield is typically made from a stainless steel material and by deforming the shield slightly it may be fitted inside an appropriate pipe diameter. Between the two barriers is arranged an engagement and locking mechanism such that a rodent such as for example a rat trying to pass the entry of the deterrent device in an upstream direction will not be able to pivot the first shield, whereas water and in particular sewage moving from upstream towards downstream will push the second barrier whereby the locking mechanism between the first and second barriers is released and the shields are allowed to pivot.

A similar rat barrier is known from EP2113615.

One drawback of the prior art devices is the fact that the barriers, axles and locking mechanisms are all arranged inside the shield and as such occupy part of the sewer pipe's cross section such that the maximum flow in the sewer is limited by the presence of the rodent deterring device. Furthermore, the locking mechanism relying on axles telescopically arranged and engagement/locking members is vulnerable in that items carried by the sewage may become stuck around the axles, telescopes or locking members and thereby first of all causing the device not to work properly, but also secondly items being stuck in the device will furthermore take up part of the cross section such that the theoretical liquid flow through a sewer pipe is drastically reduced.

### OBJECT OF THE INVENTION

Consequently, it is an object of the present invention to provide an improved device which alleviates the disadvantages mentioned above and provide further advantages.

### DESCRIPTION OF THE INVENTION

The invention addresses this by providing a rodent guard for installation in a substantially circular pipe opening, where said guard comprises a flexible shield and two barriers pivotably suspended from said shield, where said barriers are arranged in close proximity of each other, characterised in that each barrier has a blade and a mounting member projecting from said blade, where the mounting member comprises means for pivotably mounting the barrier in the shield, and that in a distal portion of the mounting member means are provided for engaging the other barrier and/or the other barrier's mounting member in a certain relative position of the two barriers.

As the barriers are mounted in a shield, they will be able to pivot such that the blades of the barriers are substantially flush with the shield in which position they do not diminish the actual flow area of the sewer pipe seriously. Furthermore, by arranging the pivot points in engagement sections in the shield these are not directly exposed to the sewage and thereby items in the sewage, such that they are at least partly shielded from any matter being transported by the sewage which could otherwise become entangled in the mechanism thereby firstly hinder the mechanism in its proper functioning and secondly diminish the actual flow area.

In a further advantageous embodiment of the invention an elongated aperture is provided in the shield, where the mounting member of each barrier projects through the aperture, and where the means for pivotably mounting the barrier relative to the shield comprise one or more projections arranged on the mounting member, which projections are received in receiving notches arranged on the shield, adjacent the aperture.

By providing an aperture in the shield it is possible to allow the mounting members to project through the aperture and therefore arrange the receiving notches on the outside of the shield whereby the inside of the shield surface, i.e. the surface of the shield facing the sewage channel will be substantially flush with only the mounting members and the blades of the barriers projecting into the sewer channel's cross section. In this manner it is ensured that the working parts of the rodent guard are shielded to the largest extent possible from the sewage.

In a further advantageous embodiment of the invention a lid is provided which lid covers the aperture, but provides room for the projecting parts of the mounting members, where said lid allows the mounting members to pivot, but hinders disengagement of the projections from the receiving notches.

In this embodiment the lid serves a number of purposes. Firstly, it serves to cover the projecting parts of the mounting members such that foreign matter is not allowed to be entangled in the projecting parts. The projecting parts of the mounting members ensure that when the two barriers are in a certain relative position it is impossible to move the barrier. The passage of a rodent in that particular direction is thereby effectively blocked. It is therefore important that the projecting members are protected from interference from foreign objects which could otherwise become entangled in the mechanism thereby rendering the rodent guard in a non-operational mode.

The second purpose of the lid is to avoid that the mounting members become disengaged from the receiving notches such that it will be possible for a rodent to pass the barriers due to malfunction in the device.

In a still further advantageous embodiment of the invention a removable deformation tool is provided, and where two or more mounting towers are provided on the outer side of the shield, said tool comprising means for engaging engagement projections on said mounting towers where when said deformation tool is inserted between two mounting towers the shield's periphery is compressed.

As the shield is flexible the deformation tool inserted between the mounting towers will deform the shield thereby compressing the periphery of the shield. Although the shield is not perfectly circular it may be compared to providing the shield with a smaller radius as the deformation tool is inserted between the two mounting towers on the shield. In this configuration the shield will typically have a “radius” which is smaller than the sewer pipe into which it is to be inserted such than when inserting the rodent guard into the sewer pipe this may occur completely without interfering with the sidewalls of the sewer. Naturally, when removing the deformation tool due to the flexibility of the shield it will flex back to its original shape thereby gaining a larger relative radius than what it was when the deformation took place whereby the shield will engage the sidewall of the sewer pipe and thereby be mounted inside the sewer pipe by friction.

In a still further advantageous embodiment of the invention in use the upstream barrier is the front barrier and the downstream barrier is the rear barrier, where the mounting member of the front barrier comprises a distal end pointing towards the rear barrier, where said distal end of said front barrier comprises a curved surface, and where the mounting member on the rear barrier comprises an indentation facing the curved surface of the mounting member of the front barrier, and where the barriers are arranged at a mutual distance, such that in at least one position of the barriers the curved surface of the front barrier's mounting member engages the indentation of the rear barrier's mounting member.

The details relating to how the engagement between the mounting members of the two barriers is achieved provide for a mechanically simple and therefore also mechanically safe engagement and locking solution. By dimensioning the curved surface correctly relative to the indentation and placing the two barriers in the correct relative distance it is achieved that the barriers may pivot independently of each other unless they are in a position where the curved surface is in engagement with the indentation in which position pivoting of the barriers relative to the shield is hampered due to the engagement.

In a still further advantageous embodiment of the invention the barriers are removably arranged in the receiving notches on the shield and optionally a lid is provided for maintaining the projections in engagement with the receiving notches, and covering said aperture.

This embodiment is quite interesting in that by being able to detach the barriers from the shield it is possible to substitute the arrangement of the barriers such that the device by arranging the barriers correctly may be inserted in a sewer pipe opening regardless of the water flow direction at that particular position, simply by arranging the barriers correctly. Therefore, by arranging the barriers removably in the receiving notches one device is suitable both for “left-hand” and “right-hand” flow with the same parts. Optionally a lid may be provided for the same reasons as mentioned above, and even more so, when the barriers are removably arranged the risk of the barrier's mounting members becoming dislodged from the receiving notches is increased which by the provision of a lid may again be safeguarded.

In a still further advantageous embodiment of the invention all parts of the rodent barrier are made from plastics. Plastics are both cheap and easy to manufacture and very light-weight, and as such the inventive rodent guard in practice only comprises three parts i.e. two barriers and a shield and an optional fourth part, i.e. the lid, is a very simple light-weight and reliable construction. Furthermore, tests have indicated that although rats are known to eat or bite into anything, a relatively hard plastic will deter the rodents from attacking the rodent guard whereby also a long life expectancy is ensured. The hardness is obtained by adding a substantial glass powder fraction to the plastic compound. Especially the barriers shall be made from a hard plastics.

By especially manufacturing the shield from a plastic material it will inherently be flexible, and therefore the advantageous mounting, of the device as described above will also be achieved with this choice of material.

In a further advantageous embodiment the shield has a circular cross section and a certain length perpendicular to the cross section, and the barriers are substantially circular or oval.

Especially the length perpendicular to the cross section is important in that in the embodiments of the invention where the receiving notches, mounting towers, lids etc. are provided, these will all extend from the upper side of the shield and as such when the rodent guard is to be mounted in a sewer pipe these will be mounted outside the cross section of the sewer pipe.

Therefore, by providing a substantial length perpendicular to the cross section a part of that length will extend outside the sewer pipe's complete cross section and a part will be inserted into the sewer pipe and become lodged as explained above due to the flexibility of the shield.

The invention is also directed at a method for installing a rodent guard as explained above, where said rodent guard and a certain length perpendicular to the cross section and the barriers are substantially circular or oval.

The invention is also directed at a method for installing a rodent guard as explained above where said rodent guard is installed in an open ended and accessible sewer pipe, where said method comprises the following steps:
a) a front and rear barrier is installed in the shield, by inserting mounting members provided on the barriers, through an aperture in said shield, where said mounting members are provided with projections which are adapted to be received in receiving notches provided adjacent to the aperture on the shield;
b) inserting a deformation tool between mounting towers provided on the shield, thereby compressing the shields circumference, and attaching a wire to said deformation tool;
c) releasably arranging a mounting pole to the outside of the shield;
d) inserting said pole and wire into the sewer pipe, until part of the shield is inside the sewer pipe, and a part of said shield including the mounting towers projects outside said sewer pipe;
e) by tensioning the wire, releasing the deformation tool from the mounting towers, whereby the shield expands its circumference, and is fastened inside the sewer pipe by frictional engagement:
f) detaching the mounting pole from the shield, and withdrawing the mounting pole, deformation tool and wire.

### DESCRIPTION OF THE DRAWING

The following is a detailed description of the drawing wherein

FIG. 1 illustrates a perspective view of a rodent guard

FIG. 2 illustrates a cross section perpendicular to the flow direction

FIG. 3 illustrates a cross section of the rodent guard in the flow direction

FIG. 4 illustrates a plain view of the shield as seen from above

FIG. 5 illustrates the shield without the barriers and lid

FIG. 6 illustrates the front barrier

FIG. 7 illustrates the rear barrier

### DETAILED DESCRIPTION OF THE INVENTION

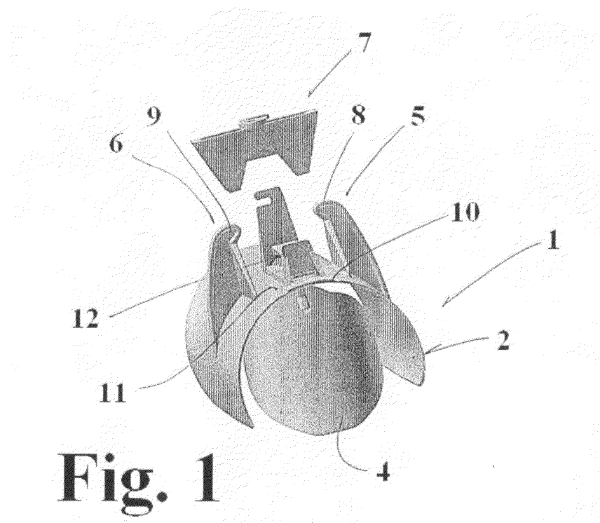

In FIG. 1 is illustrated an embodiment of the invention. The rodent guard 1 comprises a shield 2 as well as two barriers where only the rear barrier 4 is visible. On top of the shield 2 are arranged mounting towers 5, 6. A deformation tool 7 is indicated and by inserting the deformation tool 7 between the mounting towers 5, 6 the engagement projections 8, 9 will be forced apart such that the periphery of the shield 1 will be compressed. In this particular embodiment deformation grooves 10, 11 are provided in the shield such that the deformation/compression of the shield will occur along these grooves, as the deformation tool 7 is inserted between the engagement projections 8, 9.

Also visible is a lid 12 which lid 12 serves to protect the mounting members of the barriers as will be explained below.

In FIG. 2 is illustrated a cross section perpendicular to the liquid flow through a rodent guard. As is evident from the illustration the shield 2 in this non-compressed position has an inner radius substantially larger than the cross section of the barrier 4, and as such there is room to compress the shield in order to install and fix it inside a sewer pipe without the shield interfering with the barrier.

What is also evident from the cross section is that apart from the barrier 4 the cross section is completely free from other obstacles such that the effective water flow area through a pipe in which a rodent guard according to the present invention is installed is substantially maintained at its 100% capability. As is evident from for example FIG. 1 the barrier is furthermore curved, such that as the barrier is pivoted up, the shape of the barrier will follow the inner shape of the shield, whereby the barriers in their uppermost position will only take up a minimum of cross-sectional flow area.

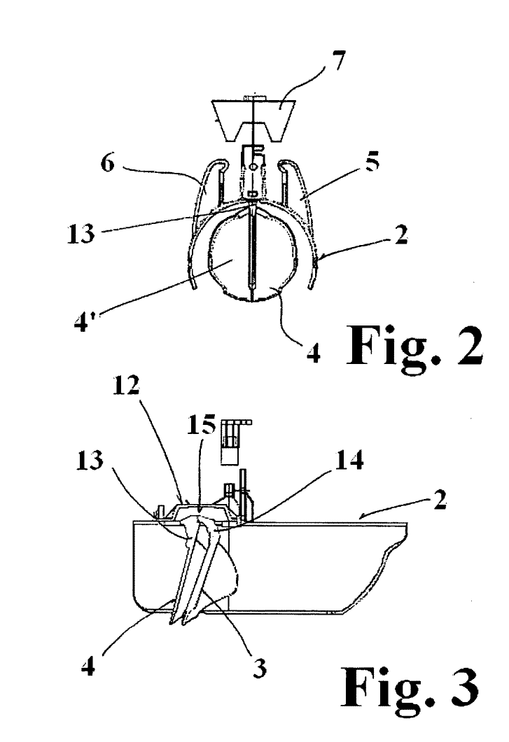

Turning to FIG. 3 a longitudinal cross section through a device according to the invention is illustrated. In this view it is possible to see both barriers 3, 4 and realize that they are mounted in close proximity to one another.

The barriers comprise a blade, see FIG. 2, which blade 4′ is dimensioned such that the blade substantially blocks the passage in a sewer pipe. Test have, however, indicated that a free space of approximately 5-15 mm between the edge of the blade 4′ and the inner side of the shield 2 is insufficient for rodents such as rats to pass the rodent guard. The barrier 4 is furthermore provided with a mounting member 13 projecting from the blade.

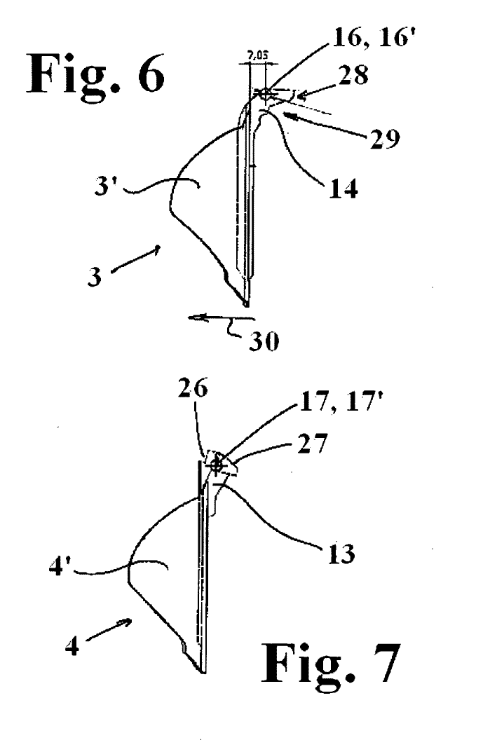

As is evident from FIG. 3 the projecting mounting members 13, 14 of the barriers 4, 3 respectively, are shaped such that they mutually engage in the point 22 in that particular relative position of the two barriers 3, 4. In the position illustrated in FIG. 3 it is impossible for a rodent such as for example a rat to lift the rear barrier in order to pass the rodent guard. This is due to the engagement of the mounting members 13, 14 in the point 15. The engagement will be further explained with reference to FIGS. 6 and 7.

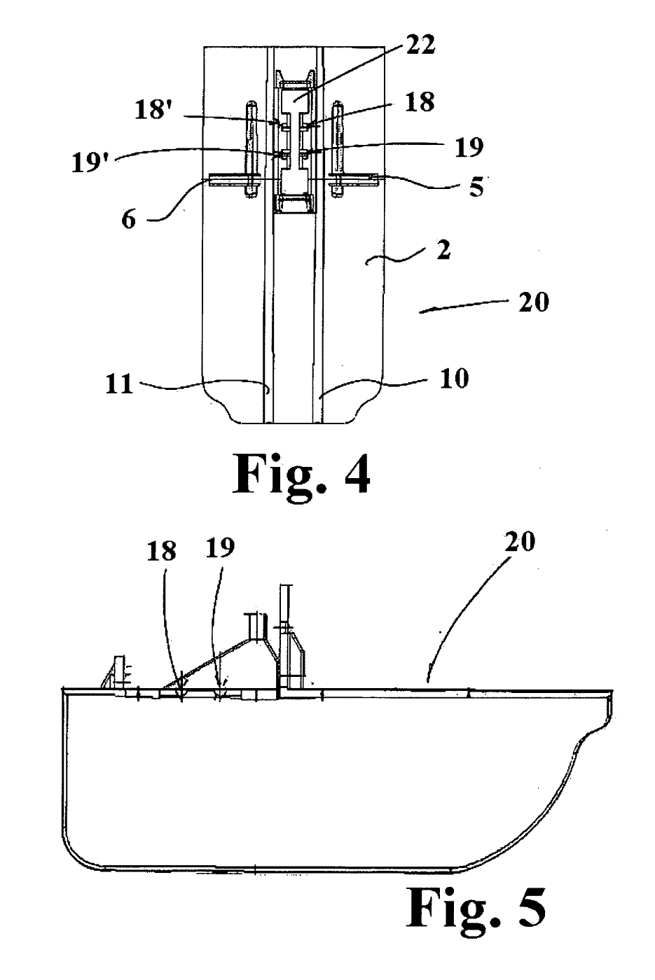

In FIG. 4 is illustrated a plain view of the shield 2 seen from above where the deformation grooves 10, 11 are clearly indicated.

Furthermore, in the shield is provided an aperture 22 where the aperture is dimensioned such that projections 16, 17, see FIGS. 6, 7, together with the mounting member 13, 14 will be able to pass out through the wall of the shield 2. Furthermore, receiving notches 18, 18′, 19, 19′ are provided adjacent the aperture 15 such that the projections 16, 16′, 17, 17′, see FIGS. 6, 7, may be releasably accommodated in the receiving notches. In this manner it is possible to arrange the barriers as indicated in FIG. 3. By rotating the barriers about a vertical axis and arranging them in the receiving notches 18, 18′, 19, 19′ it is possible to arrange the same barriers in an opposite constellation to what is depicted in FIG. 3 without having to alter anything in the device. In the barriers opposite position, it is clear that it will not be possible for a rat to pass in the opposite direction.

In FIG. 5 the receiving notches 18, 19 are illustrated. As is evident, the notches are simply depressions in the material such that the projections 16, 16′, 17, 17′ may simply be inserted and depressed into the notches 18, 19 in order to mount the barriers. The lid illustrated in FIGS. 1 and 3 serves to maintain, the mounting members 13, 14 in their proper position relative to the receiving notches 18, 19.

In embodiments not having a lid and where it is not necessary to mount the barriers 3, 4 in a removable manner the means for allowing the pivotable movement of the barriers in the shield may of course be constructed in a different manner. What is also evident from FIGS. 4 and 5 is the fact that only approximately half the length of the shield is provided with features extending radially outside the perimeter of the shield such that the other half 20 is suitable to be inserted into a substantially circular sewer pipe, and due to the compression of the shield as already explained above with reference to the discussion of the mounting towers and the deformation tool, a firm and reliable mounting of the shield inside a sewer pipe is achieved.

FIGS. 6 and 7 illustrate the front and rear barriers respectively, the blades 3′, 4′ of the barriers 3, 4 are substantially identical, whereas the mounting members 13, 14 are distinctively different. The mounting member 13 is provided with projecting pins 17, 17′ which are used in order to hingely connect the barrier 4 to the receiving means 18, 18′ (see FIG. 4). The mounting member is furthermore provided with a notch 26 and a cam section 27.

In FIG. 6 the mounting member 14 the mounting member 14 of the front barrier 3 comprises a curved section 28 and a secondary convex section 29.

When the barriers 3, 4 are arranged in the shield as illustrated in FIG. 3, the curved section 28 of the front barrier will interfit with the notch 26 of the rear barrier. In this position as illustrated in FIG. 3 the design of the notch 26 will not make in possible to pivot the front barrier 3 in the direction indicated by the arrow 30 due to the engagement between the curved section 28 and the notch 26. In the opposite direction as indicated by the arrow 30 the water will be able to push the barrier 3 such that the curved section 28 disengages the notch 26 whereby both barriers 3, 4 may pivot and allow sewage water to pass the rodent guard. The cam 27 on the rear barrier 4 is provided in order to allow the barrier 4 to pivot relative to the mounting member 14 of the front barrier 3.

1. Rodent guard for installation in a substantially circular pipe opening, where said guard comprises a flexible shield and two barriers pivotably suspended from said shield, where said barriers are arranged in close proximity of each other, wherein each barrier has a blade and a mounting member projecting from said blade, where the mounting member comprises means for pivotably mounting the barrier in the shield, and that in a distal portion of the mounting member means are provided for engaging the other barrier and/or the other barrier's mounting member in a certain relative position of the two barriers and that an elongated aperture is provided in the shield, where the mounting member of each barrier projects through the aperture, and where the means for pivotably mounting the barrier relative to the shield comprise one or more projections arranged on the mounting member, which projections are received in receiving notches arranged on the outside of the shield, adjacent the aperture.

2. Rodent guard according to claim 1 wherein a lid is provided, which lid covers the aperture, but provides room for the projecting parts of the mounting members, where said lid allows the mounting members to pivot, but hinders disengagement of the projections from the receiving notches.

3. Rodent guard according to claim 1, wherein a removable deformation tool is provided, and where two or more mounting towers are provided on the outer side of the shield, said tool comprising means for engaging engagement projections on said mounting towers where when said deformation tool is inserted between two mounting towers the shield's periphery is compressed.

4. Rodent guard according to claim 1 wherein in use the upstream barrier is the front barrier and the downstream barrier is the rear barrier, where the mounting member of the front barrier comprises a distal end pointing towards the rear barrier, where said distal end of said front barrier comprises a curved surface, and where the mounting member on the rear barrier comprises an indentation facing the curved surface of the mounting member of the front barrier, and where the barriers are arranged at a mutual distance, such that in at least one position of the barriers the curved surface of the front barrier's mounting member engages the indentation of the rear barrier's mounting member, thereby hindering relative pivoting of the two barriers, and the barriers relative to the shield.

5. Rodent guard according to claim 1 wherein the barriers are removably arranged in the receiving notches on the shield and optionally a lid is provided for maintaining the projections in engagement with the receiving notches, and covering said aperture.

6. Rodent guard according to claim 1 wherein all parts of the rodent barrier are made from plastics, and in particular plastics containing glass powder.

7. Rodent guard according to claim 1 wherein the shield has a cross section corresponding to part of a circle and a certain length perpendicular to the cross section, and that the barriers are substantially circular or oval.

8. Rodent guard according to claim 1 wherein the barriers are substantially non-planar, and are provided with a single or double curved shape.

9. Method for installing a rodent guard according to claim 1, where said rodent guard is installed in an open ended and accessible sewer pipe, where said method comprises the following steps:
a) a front and rear barrier is installed in the shield, by inserting mounting members provided on the barriers, through an aperture in said shield, where said mounting members are provided with projections which are adapted to be received in receiving notches provided adjacent to the aperture on the shield;
b) inserting a deformation tool between mounting towers provided on the outside of the shield, thereby compressing the shields circumference, and attaching a wire to said deformation tool;
c) releasably arranging a mounting pole to the outside of the shield;
d) inserting said pole and wire into the sewer pipe, until part of the shield is inside the sewer pipe, and a part of said shield including the mounting towers projects outside said sewer pipe;
e) by tensioning the wire, releasing the deformation tool from the mounting towers, whereby the shield expands its circumference, and is fastened inside the sewer pipe by frictional engagement:
f) detaching the mounting pole from the shield, and withdrawing the mounting pole, deformation tool and wire.
